(19) United States
(12) Patent Application Publication
(10) Pub. No.: US 2023/0367130 A1
(43) Pub. Date: Nov. 16, 2023

(54) HEAD-MOUNTED OR HELMET-MOUNTED DISPLAY MODULE

(71) Applicant: THALES, Courbevoie (FR)

(72) Inventor: Joel BAUDOU, SAINT MEDARD EN JALLES (FR)

(21) Appl. No.: 18/196,570

(22) Filed: May 12, 2023

(30) Foreign Application Priority Data
May 12, 2022 (FR) 2204491

(51) Int. Cl. G02B 27/01

(52) U.S. Cl. CPC G02B 27/0176

(57) ABSTRACT

A viewing system intended to interact with a cranial mount, the viewing system includes a detachable displaying device, comprising: a combiner, placed in front of one eye of the user, and able to place information in superposition with an exterior view, the viewing system comprising a removable mounting interface configured to associate the displaying device with a plurality of cranial mounts among at least a helmet, a headband and a head-harness frame.

### CROSS-REFERENCE TO RELATED APPLICATION

This application claims priority to foreign French patent application No. FR 2204491, filed on May 12, 2022, the disclosure of which is incorporated by reference in its entirety.

### FIELD OF THE INVENTION

The technical field of the invention is that of viewing systems for aircraft pilots. More precisely, the field of the invention is that of systems simultaneously combining goggles/binoculars and a head-mounted display.

### BACKGROUND

A viewing system may comprise three different pieces of viewing equipment. These are a protective visor, a head-mounted display and goggles/binoculars, which may be night-vision goggles. In the rest of the description, the expression head-mounted display will also be used to refer to a helmet-mounted display. The acronym “NVG” will further be used to designate night-vision goggles.

Night-vision goggles capture light emitted by objects in the near infrared and render a visible image by virtue of image intensifiers. They comprise two identical bodies. Each of the bodies comprises three main portions, namely an objective, the image intensifier and an eyepiece. The visual field of the NVG, which is set by the eyepiece, generally has a diameter of 40 degrees. To make it possible to see the entirety of the intensified image, the eyepiece of the NVG is generally placed at about 25 mm from the eye.

A head-mounted display displays a synthetic image or video collimated to infinity in superposition on the exterior by means of a projecting optic and of an optical combiner. The image is generally generated by a flat-panel screen comprising a light source and the circuit board used to drive it. The projecting optic collimates the image transmitted to the combiner. To decrease the dimensions of this element, pupil-expanding combiners are used. The combiner is then an optical plate consisting of a plurality of prisms that reflect, towards the eye, the light of the synthetic image.

Currently, certain surveillance missions do not necessarily require a hard protective helmet to be used, and a simple headband or head harness, which is lighter, may be used, in order to free the head of the operator from the weight of the protective helmet. By way of example, in the case of a maritime surveillance mission, which may last several hours, and during which an operator is on board an aeroplane, a helicopter, or any other type of aircraft, the operator will spend a considerable amount of time observing the surface of the sea, and the flight crew, including the operator, will be equipped only with a hard headband or a head harness in order to dispense with a heavy protective helmet.

In order to assist the operator with his or her surveillance, a device for displaying information in front of his or her eye may be fastened to the headband or to the head harness so as to display information essential to conducting a surveillance mission. However, NVG are too heavy and bulky to be installed on a headband or a head harness and are generally fastened to hard protective helmets. In addition, information related to the aircraft and to flight conditions are generally displayed on screens in the cockpit or cabin.

Thus, when night falls, the operator must replace the headband or head harness with a protective helmet in order to be able to continue the surveillance at night. However, the operator is then required to lower his or her head in the direction of the screens of the cockpit in order to be able to read essential information on his or her environment, on the aircraft, etc. Now, the alternation between surveillance of the exterior environment and observation of the screens of the cockpit, requiring the operator to lower his or her head, makes it more difficult for the operator to monitor the situation as it decreases the time the operator is able to spend on surveillance of the exterior environment. Furthermore, this alternation also greatly tires the operator, this also making it more difficult to successfully complete the surveillance mission.

Besides at night, any variation in light level may require the displaying device to be replaced by goggles/binoculars or vice versa. Similarly, the topology and geography of the environment may oblige the operator, during the surveillance mission, to replace the displaying device with goggles/binoculars or vice versa. Specifically, when the environment on the ground is a uniform expanse, a displaying device seems to suffice. Nevertheless, when a relief is observable in the environment on the ground, goggles/binoculars seem the most appropriate and replacement of the displaying device and head harness with goggles/binoculars and the helmet bearing them may be required.

Thus, the hard headband or head harness bearing the displaying device may need to be replaced with the helmet bearing the goggles/binoculars (NVG inter alia) and vice versa at least once, and very often several times, during the surveillance mission of the operator. These multiple changes take up a non-negligible amount of time, during which the operator cannot perform his or her surveillance mission. These multiple changes also cause further fatigue to the operator, during a surveillance mission that may last a very long time.

In addition, combined use of a headband or head harness during the day and a helmet with NVG during the night greatly increases the crampedness of the post of the operator.

### SUMMARY OF THE INVENTION

The invention aims to mitigate all or some of the aforementioned problems, by providing a removable helmet-mounted display with fastenings compatible with mounting on a helmet or a head-harness headband and of a volume compatible with goggles/binoculars.

More precisely, the invention therefore provides a viewing system comprising removable viewing equipment such as a displaying device or NVG that may be fastened to a hard protective helmet or to a hard headband or a head harness.

To this end, one subject of the invention is a viewing system intended to interact with a cranial mount, said viewing system comprising:
a detachable displaying device, comprising:
   a combiner, placed in front of one eye of the user, and able to place information in superposition with an exterior view,
      the viewing system comprising a removable mounting interface configured to associate the displaying device with a plurality of cranial mounts among at least a helmet, a headband and a head-harness frame.

According to one aspect of the invention, the detachable displaying device comprises a goggles/binoculars-mount-fastening interface, the viewing system comprising detachable goggles/binoculars, the goggles/binoculars comprising a goggles/binoculars mount able to be fastened against the displaying device via mechanical association of the goggles/binoculars-mount-fastening interface and the goggles/binoculars mount in such a way that the displaying device is located between the eye of the user and the goggles/binoculars.

According to one aspect of the invention, the removable mounting interface comprises:
a first fastening system mounted on the removable mounting interface,
a second fastening system complementary to the first fastening system, mounted on the cranial mount,
   the first fastening system being configured to be associated with the second fastening system so as to secure the first fastening system.

According to one aspect of the invention, the first fastening system comprises a rail system and the second fastening system comprises a T-shaped groove.

According to one aspect of the invention, the rail system comprises a serrated device and the T-shaped groove comprises a ball-plunger system.

According to one aspect of the invention, the T-shaped groove is rotatable about a transverse axis one component of which is perpendicular to a visual field of the user.

According to one aspect of the invention, the second fastening system is rotatable about a second axis parallel to the visual field of the user.

According to one aspect of the invention, the viewing system is intended to be associated with a helmet, the helmet comprising a fitting plate connected to the second fastening system and to the goggles/binoculars-mount-fastening interface, the displaying device and the goggles/binoculars being translatable with respect to the fitting plate of the helmet along a vertical axis perpendicular to the transverse axis and to the visual-field second axis.

According to one aspect of the invention, the displaying device comprises a first magnetic pole and the viewing system comprises a moveable visor, the moveable visor comprising a second magnetic pole that is complementary to the first magnetic pole, and that is magnetically connected to the first magnetic pole in such a way as to keep the moveable visor in contact with the displaying device.

According to one aspect of the invention, the removable mounting interface comprises:
a first fastening system mounted on the removable mounting interface,
a second fastening system complementary to the first fastening system, and intended to be mounted on the cranial mount,
   the first fastening system being configured to be associated with the second fastening system so as to secure the first fastening system, the viewing system being intended to be associated with a helmet, the helmet comprising a fitting plate connected to the second fastening system of the displaying device, the moveable visor comprising a fastening strip connected to the fitting plate of the helmet.

According to one aspect of the invention, the goggles/binoculars are night-vision goggles comprising two identical bodies, each body comprising one eyepiece.

According to one aspect of the invention, the displaying device comprises a flat-panel screen, its light source, a collimating optic and a pupil-expanding optical combiner.

### BRIEF DESCRIPTION OF THE DRAWINGS

The invention will be understood better and further advantages will become apparent on reading the detailed description of an embodiment given by way of example, the description being illustrated by the appended drawing, in which:

FIG. 1 shows a viewing system according to the invention interacting with a head harness;

FIG. 2 shows the viewing system according to the invention interacting with a protective helmet;

FIG. 3 shows a displaying device according to the invention;

FIG. 4 shows a double fastening system of the displaying device, in order to interact with the head harness;

FIG. 5 shows the viewing system of FIG. 2 invention interacting with the head harness in a second configuration;

FIG. 6 shows a system for managing the height of the displaying device on a helmet;

FIG. 7 shows the double fastening system of the displaying device interacting with the protective helmet;

FIG. 8 shows the viewing system of FIG. 1 in a second configuration;

FIG. 9 shows the viewing system comprising a sun visor interacting with a protective helmet.

For the sake of clarity, elements that are the same have been designated by the same references in all the figures.

### DETAILED DESCRIPTION

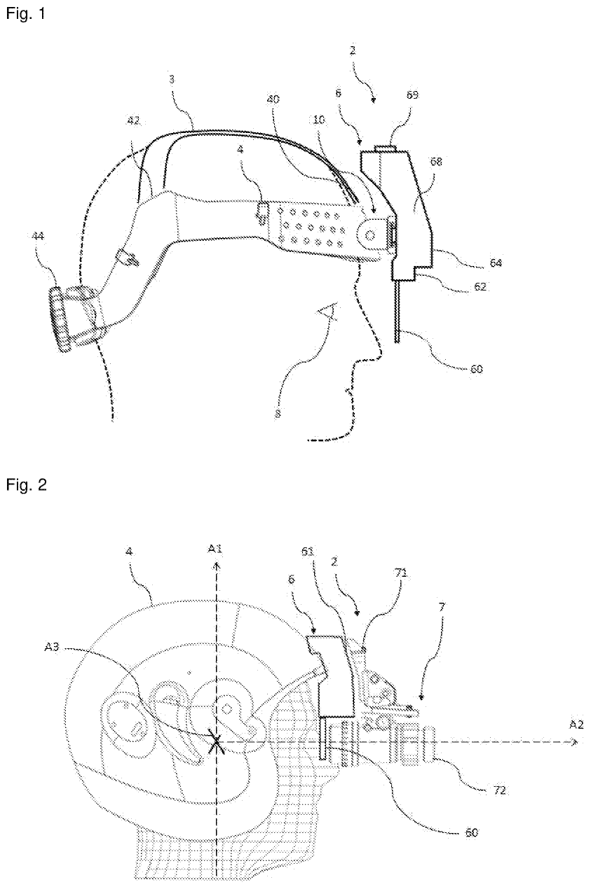

FIG. 1 shows a viewing system 2 according to the invention and intended to interact with a cranial mount 4. The cranial mount 4 is defined to be a mount comprising a hard part that rests on the cranium of a user. By way of indicative example, the cranial mount 4 is a protective helmet, a head harness or a headband. In the rest of the description of FIG. 1, the cranial mount 4 is a head harness. The viewing system 2 comprises a displaying device 6 that is detachable from the cranial mount 4. The displaying device 6 comprises a combiner 60, placed in front of one eye 8 of the user wearing the cranial mount 4, and the viewing system 2. The combiner 60 is able to place information in front of the eye 8 in superposition with an exterior view.

The viewing system 2 also comprises a removable mounting interface 10 configured to associate the displaying device 6 with a plurality of cranial mounts 4 among at least a helmet, a headband and a head-harness frame. Preferably, the cranial mount 4, and particularly the headband and the head harness, is a hard mount, i.e. the structure of the cranial mount 4 is hard enough to support at least the displaying device 6 and other pieces of visual equipment. Thus, the cranial mount may be any other mount resting on the cranium of the operator and having a sufficient hardness to support pieces of visual equipment. Specifically, the viewing system 2 has the advantage of being able to be associated with a headband or head harness as shown in FIG. 1 and, when night falls, to be detached from the cranial mount 4 used, namely the head harness, and then to be associated with another cranial mount 4, of structure different from the head harness, such as a helmet for example (as shown in FIG. 2), equipped with NVG allowing the operator to see at night. Thus, the visual equipment, namely the displaying device 6, is detachable and compatible with any cranial mount worn on-board by the operator, and hence the operator need not cramp himself or herself with a plurality of identical pieces of visual equipment on different cranial mounts.

Therefore, the operator has available to him or her a mounting means, namely the removable mounting interface 10, allowing the displaying device 6 to be mounted on a helmet or on a frame and allowing a frame or head harness to be exchanged for a helmet in flight.

The head harness 4 comprises, optionally, a strap 3 linking a frontal face 40 of the head harness 4 to a rear face 42 of the head harness 4, so as to improve the positioning of the head harness 4 on the cranium of the operator.

The head harness 4 also comprises a counterweighting means 44 for adding ballast to the head harness 4, which means is positioned at the rear of the cranium of the operator with respect to his or her visual field, and which means allows the weight at the front of the head harness 4 induced by the position of the displaying device 6 to be compensated for, and thus a balance on the cranium of the operator to be obtained. Therefore, the mass of the counterweighting means 44 is at least equivalent to the mass of the displaying device 6. By way of indicative example, the counterweighting means 44 has a mass of about 200 grams.

Furthermore, the counterweighting means 44 is also a means for adjusting the head harness 4, to fit it to the morphology of the head of the operator. The pressure against the neck helps keep the head harness 4 considered in its entirety in place and stable on the head of the operator. The head harness 4 is counterweighted to compensate for the additional mass at the front.

The displaying device 6 comprises a flat-panel screen, its light source and the control electronics 68, a collimating optic 62, an imager 64 incorporating the light source and the pupil-expanding optical combiner 60.

The collimating optic 62 and the imager 64 are located in the bottom portion of the displaying device 6 and the control electronics 68 are positioned in the top portion of the displaying device 6.

The displaying device comprises, according to one variant, a position sensor 69 located in the top portion, allowing correct positioning of the displaying device 6 to be detected.

Direct connection between the displaying device 6 and the position sensor 69 thus has the advantage of allowing the position of the displaying device 6 to be automatically controlled, in real time, in order to obtain a perfect correspondence with the visual field of the operator. In other words, the displaying device 6 comprising the position sensor 69 does not require readjustment of alignment of the display on the information of the sensor after exchange in flight.

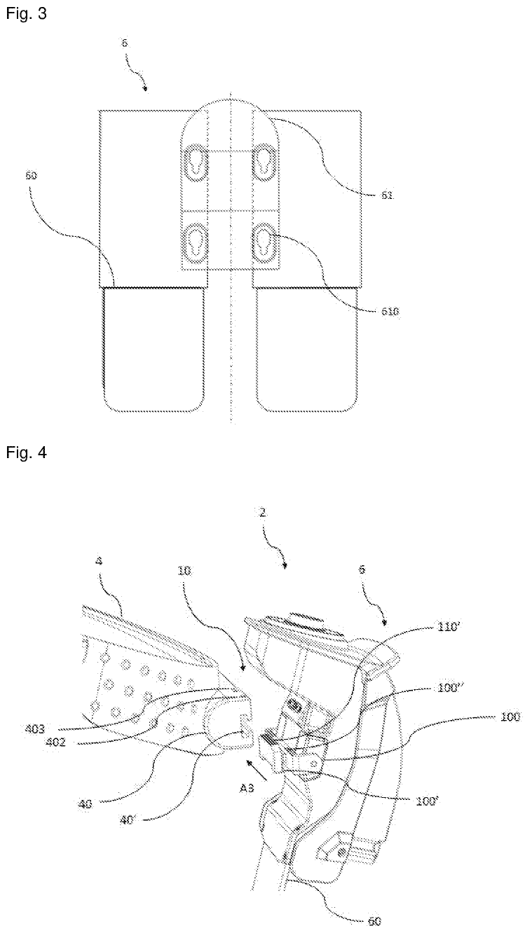

The detachable displaying device 6 also comprises a goggles/binoculars-mount-fastening interface 61 (shown in FIG. 2, and in more detail in FIG. 3). Specifically, once night has fallen, the operator must remove the head harness in order to change cranial mount 4 in order to use the goggles/binoculars 7. Therefore, the cranial mount 4 becomes, in the case of the description of FIG. 2, a protective helmet 4. The viewing system 2 then comprises goggles/binoculars 7 such as detachable night-vision goggles (NVG) associated with the helmet 4. The goggles/binoculars 7 comprise a goggles/binoculars mount 71 able to be fastened against the displaying device 6 via mechanical association of the goggles/binoculars-mount-fastening interface 61 and the goggles/binoculars mount 71 in such a way that the displaying device 6 is located between one eye 8 of the operator and the goggles/binoculars 7. Thus, the displaying device 6 is fastened against the helmet 4, by way of the removable mounting interface 10, in such a way that the combiner 60 is able to place information in front of the eye 8 of the operator, in superposition with an exterior view delivered by way of the goggles/binoculars 7 fastened against the displaying device 6.

Other types of goggles/binoculars may be envisaged instead of NVG. The goggles/binoculars 7 comprise two identical bodies, each body comprising one eyepiece 72. More precisely, when the goggles/binoculars 7 are NVG, each NVG body comprises, in this order, an objective, a device for intensifying the light of the image delivered by the objective and the eyepiece 72, which forms an image at infinity from the intensified image. The goggles/binoculars 7 are installed with the eyepiece 72 making contact with the combiner 60 in order to respect the distance allowing the eye to see the entire field of the intensified image. What is meant by “making contact” is that the goggles/binoculars 7 are as close as possible to the combiner 60, direct contact not being obligatory. The goggles/binoculars 7 are adjusted laterally in front of the eye by virtue of their interocular adjustment mechanism and are placed at the centre of the working portion of the combiner 60 vertically via the goggles/binoculars mount 71.

In order to increase the space available between the helmet 4 and the goggles/binoculars 7, it may be envisaged to make adjustments to the goggles/binoculars, such as, for example, a longitudinal adjustment of the goggles/binoculars 7 so as to allow the goggles/binoculars 7 and the goggles/binoculars mount 71 to be shifted along a second axis A2 parallel to the field of view of the operator. It may also be envisaged to make a vertical adjustment to the goggles/binoculars, allowing the goggles/binoculars to be shifted along a vertical axis A1 perpendicular to the visual-field second axis A2, or even to make an adjustment about a transverse third axis A3 perpendicular to the visual-field second axis A2 (or a component of which is perpendicular to the visual-field second axis A2) and perpendicular to the vertical axis A1. The space freed by these three adjustments thus allows the depth available for positioning the displaying device 6 between the eye 8 of the operator and the goggles/binoculars 7 to be defined.

The displaying device 6 is monocular and preferably is positioned in front of the dominant eye of the operator. As a variant, the displaying device 6 is binocular, as shown in FIG. 3, so as to advantageously be able to deliver a larger amount of information to the operator. The maximum width of the displaying device 6, and particularly of the combiner 60, along the transverse axis A3, is defined by the need to install one displaying device 6 on each eye and the need to reserve a space close to the sagittal plane, which plane is formed by the vertical axis A1 and the visual-field second axis A2, for the goggles/binoculars-mount-fastening interface 61.

The goggles/binoculars-mount-fastening interface 61 comprises a predefined number of notches 610, four notches 610 in the example of FIG. 3, each allowing one screw head of the goggles/binoculars mount 71 to be inserted. Therefore, a translational movement towards the combiner 60, parallel to the vertical axis A1, allows each screw head to be locked in the respective notches 610. The goggles/binoculars mount 71 is thus secured against the goggles/binoculars-mount-fastening interface 61 and therefore against the displaying device 6. By way of indicative example, the notches 610 may be rigid keyhole slots.

By way of indicative example, the goggles/binoculars-mount-fastening interface 61 may be a known part for fastening goggles/binoculars to a protective helmet.

In order to allow the displaying device 6 to be rapidly and easily fastened to any cranial mount 4, the removable mounting interface 10 comprises, as shown in FIG. 4:
a first fastening system 100 mounted on the removable mounting interface 10,
a second fastening system 40 complementary to the first fastening system 100, mounted on the cranial mount 4, namely the helmet or hard headband or the hard head-harness frame.

The first fastening system 100 is configured to be associated with the second fastening system 40 so as to secure the first fastening system 100. The first fastening system 100 and the complementary second fastening system 40 may be any male and female fastening system allowing the displaying device 6 to be secured. By way of example, the first fastening system 100 may be inserted into the second fastening system 40 and locked in the second fastening system 40 via a third part preventing a return movement of the first fastening system 100.

More precisely, the first fastening system 100 is removable and detachable from the complementary second fastening system 40 which is, for its part, fastened against the cranial mount 4.

In one preferred configuration, shown in FIG. 4, the first fastening system 100 comprises a rail system 100′ and the second fastening system 40 comprises a T-shaped groove 40′, of complementary size, allowing the rail system to be slid in.

In order to associate the displaying device 6 with the cranial mount 4, a head harness in the case shown in FIG. 4, the rail system 100′ is inserted parallel to the transverse axis A3 into the T-shaped grove 40′. The rail system 100′ also comprises a serrated device 110′ and the T-shaped groove 40′ comprises a ball-plunger system 403 allowing the rail system 100′ to be immobilized in the T-shaped groove 40′. As shown in FIG. 4, two ball-plunger systems 403 are enough to lock the rail system 100′. As a variant, more than two ball-plunger systems 403 may be envisaged. According to another variant, a single ball-plunger system 403 is enough to lock the system provided a sufficiently stiff spring is employed.

The second fastening system 40 also comprises a visual marker 402 so as to allow the rail system 100′ to be centred with respect to the eye of the operator, the visual marker 402 being able to be aligned with visual indicators 100″ present on the first fastening system 100 so as to position the displaying device 6 with respect to the eye of the operator laterally.

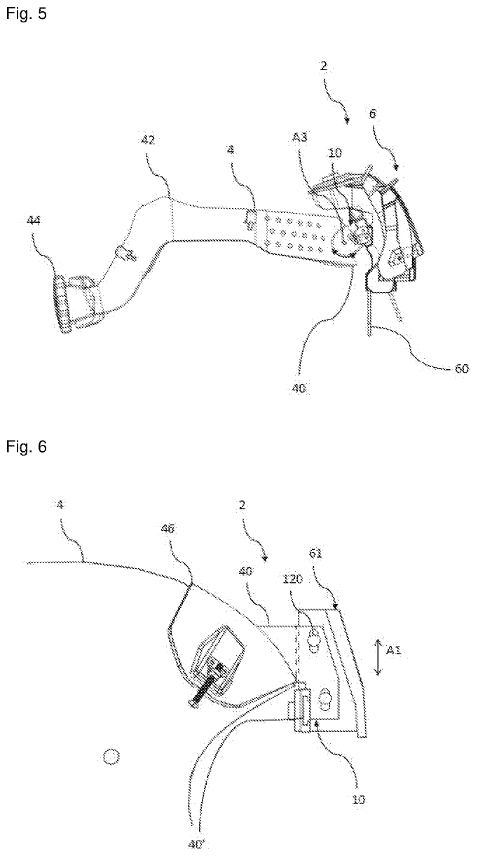

Furthermore, the T-shaped groove 40′ is rotatable about the transverse axis A3 perpendicular to the visual field of the operator. This rotatability has the advantage of allowing the displaying device 6 to be rotated and thus the displaying device 6 to be pivoted so as to remove the combiner 60 from in front of the eye and to at least partially clear the view of the operator, during flight when the presence of the displaying device 6 is optional and as shown in FIG. 5. This rotation also has the advantage of allowing placement or removal of the combiner 60 on or from the cranium of the operator to be facilitated.

According to one variant, the rail system 100′ is inserted parallel to the vertical axis A1 into the T-shaped groove 40′, which itself is positioned parallel to the vertical axis A1. This configuration thus allows the displaying device to be locked in place by way of its own weight. Nevertheless, this configuration prevents any pivoting of the displaying device 6, which must thus remain in front of the eye of the operator.

As a variant, any groove allowing the rail to be inserted by sliding and locked in place may be envisaged.

In addition, when the cranial mount 4 is a headband or a head harness, as shown in FIG. 5, the heightwise position of the combiner 60 in front of the eye of the operator is adjusted by moving the cranial mount 4 parallel to the vertical axis A1.

In contrast, when the cranial mount 4 is a helmet, as shown in FIG. 6, the position of the displaying device 6 may also be adjusted heightwise in front of the eye of the operator. Specifically, the displaying device 6, and the goggles/binoculars 7, are translatable with respect to the helmet along the vertical axis A1 perpendicular to the transverse axis and to the operator-visual-field second axis. To this end, the removable mounting interface 10 comprises an additional serration-based system 120 that is for example mounted on the second fastening system 40 and that allows the height of the first fastening system 100 to be varied.

It may also be envisaged for the helmet to comprise a fitting plate, fastened to the helmet or integrated into the helmet, said plate being connected to the second fastening system 40 and to the goggles/binoculars fastening mount 61. Therefore, the displaying device 6 and the goggles/binoculars 7 are also translatable with respect to the fitting plate of the helmet along the vertical axis A1. It may also be envisaged for the helmet 4 to comprise a frame 46 resting against the helmet 4. Therefore, the fitting plate rests against the frame 46. The frame 46 is, preferably, made of the same material as the shell of the helmet 4. The fitting plate may be an integral part of the frame 46 or be permanently fastened thereto.

Thus, the invention relates to the viewing system 2 and to the cranial mount 4, namely the helmet in the case of FIG. 6, comprising the fitting plate and/or the frame 46, in which the goggles/binoculars 7, and more particularly the goggles/binoculars-mount-fastening interface 61 possess a translatability with respect to the fitting plate and with respect to the frame 46 and the helmet 4 along the vertical axis A1.

The fitting plate is, by way of indicative example, a fitting plate known in the field of the protective helmets used in aeronautics. Similarly, the frame 46 is also a metal frame known in the field of flight helmets. The fitting plate and the frame 46 may be of integral construction, as shown in FIG. 6. The frame may, by way of example, be a banana bar or banana ski. This frame comprises a surface suitable for “permanently” fastening the goggles/binoculars mount 71 or goggles/binoculars-mount-fastening interface 61, with a view to rapid mounting of the goggles/binoculars mount 71.

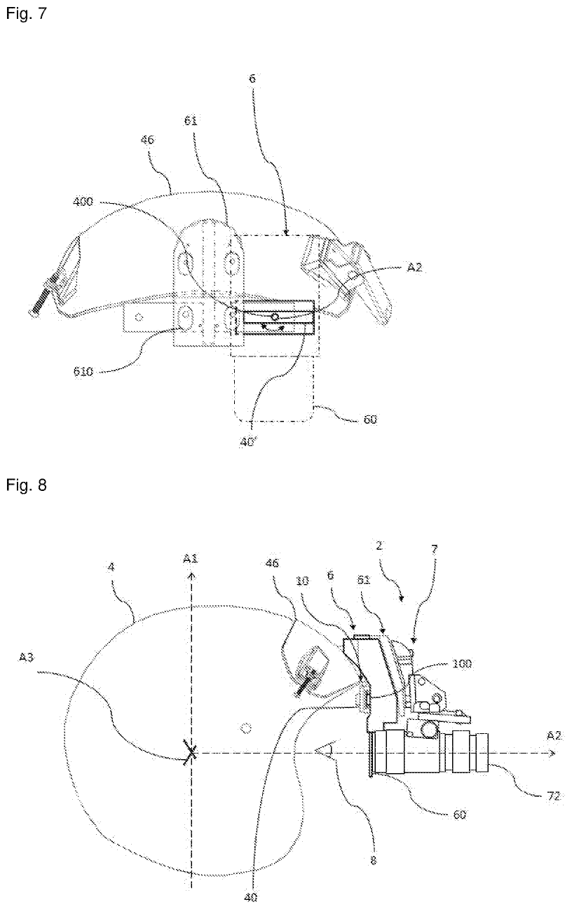

Furthermore, the displaying device 6 and particularly the combiner 60 cannot be released, with a view for example to putting the helmet 4 on, in a forwards direction, i.e. in the direction of the visual-field second axis A2, because of the presence of the goggles/binoculars 7 and of the proximity with the helmet 4. Thus, as shown in FIG. 7, the second fastening system 40 is rotatable about the operator-visual-field second axis A2. More precisely, the T-shaped groove 40′ is able to pivot about a pivot 400 parallel to the visual-field second axis A2 drawing with it the first fastening system 100. Release is then achieved via a lateral rotation away from the sagittal plane, about the pivot 400, so as to separate the combiner 60 from the eye of the operator and from the goggles/binoculars 7.

As indicated above, as the combiner 60 is installed on the side of the dominant eye of the operator, the pivot 400 is also installed on the side of the dominant eye of the operator. It may also be envisaged, in the case of use of two combiners 60, to provide two pivots 400, one pivot 400 per T-shaped groove 40′. The pivot 400 is positioned between the helmet 4 and the T-shaped groove 40′. If the helmet 4 comprises a frame 46 or a fitting plate, as in FIG. 7, the pivot 400 is positioned between the fitting plate and the T-shaped groove 40′.

FIG. 8 thus shows the viewing system 2, in which the removable mounting interface 10 comprises the first fastening system 100 mounted on the removable mounting interface 10 and the second fastening system 40 complementary to the first fastening system 100, which itself is secured in the second fastening system 40, which here is mounted on the frame 46.

When the viewing system 2 is intended to be associated with a helmet 4 and when the helmet 4 comprises the frame 46 and/or the fitting plate, the fitting plate, or the frame 46 when the helmet 4 does not comprise any fitting plate, is connected to the second fastening system 100 of the displaying device 6.

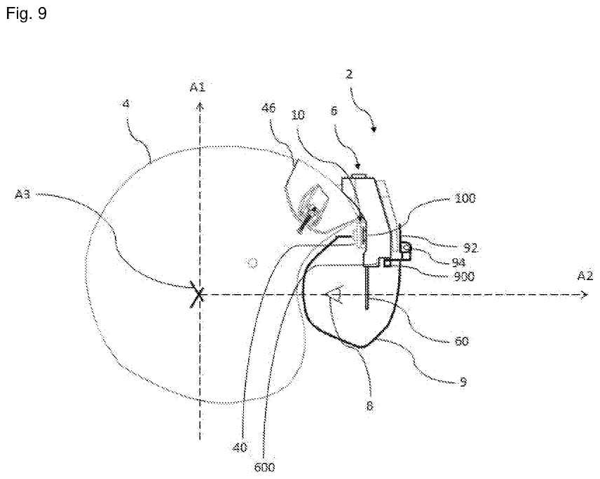

Furthermore, when the goggles/binoculars 7 are not useful but the helmet 4 is necessary or simply desired by the operator, it may be envisaged to remove the goggles/binoculars 7 from the helmet 4, as shown in FIG. 9, and simply fasten the displaying device 6 to the helmet 4. However, during the day for example, it may be envisaged to protect the eye 8 of the operator from exterior light or any other visual annoyance that the operator might be subject to, dust and particles for example. Thus, it may be envisaged to use, according to one variant, shown in FIG. 9, a moveable visor 9 allowing the eye of the operator to be protected.

Therefore, the viewing system 2 comprises the moveable visor 9, which may be, by way of indicative example, a sun visor.

When the cranial mount 4 is a helmet, as shown in FIG. 9, and in order to associate the moveable visor 9 against the displaying device 6, the moveable visor 9 comprises a strip 92 making fastening against the goggles/binoculars-mount-fastening interface 61 possible in a similar manner to fastening of the goggles/binoculars 7 so as to ensure the moveable visor 9 is kept against the displaying device 6.

The moveable visor 9 may also comprise a visor pivot 94 allowing a rotation of the moveable visor 9 to be induced parallel to the transverse axis A3 so as to remove the moveable visor 9 from the visual field of the operator. This rotation also has the advantage of allowing the displaying device 6 to be rotated about the second axis A2.

Furthermore, when the cranial mount 4 is a headband or a head harness, the strip 92 is not suitable for fastening the moveable visor 9 against the head harness 4. Therefore, the displaying device 6 comprises a first magnetic pole 600 and the moveable visor 9 comprises a second magnetic pole 900 complementary to the first magnetic pole 600. The first magnetic pole 600 and the second magnetic pole 900 are magnetically connected so as to keep the moveable visor 9 in contact with the displaying device 6. The first magnetic pole 600 and the second magnetic pole 900 suffice to fasten the moveable visor 9 against a headband or head harness.

When the cranial mount 4 is a helmet, the distance between the first magnetic pole 600 and the second magnetic pole 900 increases, this adversely affecting the magnetic retention of the moveable visor 9, and requiring it to be fastened by way of the strip 92.

A moveable visor comprising, on the one hand, the second magnetic pole 900, and on the other hand the strip 92, thus has the advantage of being suitable for being fastened to any aforementioned cranial mount 4.

The invention will also be of use to operators such as first responders or oil-rig workers who need a head-mounted display for common missions and who sometimes require night-vision goggles. Since the device can be mounted on a headband or on a helmet, the device allows a unique system to be provided. The viewing system may thus be said to be attached to the aeroplane or helicopter and the headband and helmet to belong to the pilot. The pilot chooses his or her “cranial mount” before the flight depending on his or her mission.

This second advantage of the invention in particular justifies the common visor illustrated in FIG. 9. The pilot is provided with a visor and with a viewing device that he or she may use with a headband or a helmet with or without night-vision goggles.

Thus, the invention provides a detachable displaying device 6 allowing the displaying device 6, goggles/binoculars 7 or even a moveable visor 9 to be associated with a plurality of cranial mounts such as a protective helmet, a headband or even a hard head harness. The assembly that is the viewing system thus has the advantage of being interchangeable and suitable for any in-flight surveillance situation and of decreasing operator fatigue related to use of various systems, including occasional use of heavy systems.

1. A viewing system intended to interact with a cranial mount, said viewing system comprising:
a detachable displaying device, comprising:
a combiner, placed in front of one eye of the user, and able to place information in superposition with an exterior view,
the viewing system comprising a removable mounting interface configured to associate the displaying device with a plurality of cranial mounts among at least a helmet, a headband and a head-harness frame.

2. The viewing system according to claim 1, wherein the detachable displaying device comprises a goggles/binoculars-mount-fastening interface, the viewing system comprising detachable goggles/binoculars, the goggles/binoculars comprising a goggles/binoculars mount able to be fastened against the displaying device via mechanical association of the goggles/binoculars-mount-fastening interface and the goggles/binoculars mount in such a way that the displaying device is located between the eye of the user and the goggles/binoculars.

3. The viewing system according to claim 1, wherein the removable mounting interface comprises:
a first fastening system mounted on the removable mounting interface,
a second fastening system complementary to the first fastening system, mounted on the cranial mount,
the first fastening system being configured to be associated with the second fastening system so as to secure the first fastening system.

4. The viewing system according to claim 3, wherein the first fastening system comprises a rail system and the second fastening system comprises a T-shaped groove.

5. The viewing system according to claim 4, wherein the rail system comprises a serrated device and wherein the T-shaped groove comprises a ball-plunger system.

6. The viewing system according to claim 4, wherein the T-shaped groove is rotatable about a transverse axis (A3) one component of which is perpendicular to a visual field of the user.

7. The viewing system according to claim 3, wherein the second fastening system is rotatable about a second axis (A2) parallel to the visual field of the user.

8. The viewing system according to claim 1, said viewing system being intended to be associated with a helmet, the helmet comprising a fitting plate connected to the second fastening system and to the goggles/binoculars-mount-fastening interface, the displaying device and the goggles/binoculars being translatable with respect to the fitting plate of the helmet along a vertical axis (A1) perpendicular to the transverse axis (A3) and to the visual-field second axis (A2).

9. The viewing system according to claim 1, the displaying device comprising a first magnetic pole, the viewing system comprising a moveable visor, the moveable visor comprising a second magnetic pole that is complementary to the first magnetic pole, and that is magnetically connected to the first magnetic pole in such a way as to keep the moveable visor in contact with the displaying device.

10. The viewing system according to claim 9, wherein the removable mounting interface comprises:
a first fastening system mounted on the removable mounting interface,
a second fastening system complementary to the first fastening system, and intended to be mounted on the cranial mount,
the first fastening system being configured to be associated with the second fastening system so as to secure the first fastening system,
the viewing system being intended to be associated with a helmet, the helmet comprising a fitting plate connected to the second fastening system of the displaying device, the moveable visor comprising a fastening strip connected to the fitting plate of the helmet.

11. The viewing system according to claim 2, wherein the goggles/binoculars are night-vision goggles comprising two identical bodies, each body comprising one eyepiece.

12. The viewing system according to claim 1, wherein the displaying device comprises a flat-panel screen, its light source, a collimating optic and a pupil-expanding optical combiner.
